(19) United States
(12) Patent Application Publication
(10) Pub. No.: US 2021/0127181 A1
(43) Pub. Date: Apr. 29, 2021

(54) SYSTEMS AND METHODS FOR PROVIDING REAL TIME DYNAMIC MODIFICATION OF CONTENT IN A VIDEO

(71) Applicant: Keren RAMOT, Tel Aviv (IL)

(72) Inventor: Keren RAMOT, Tel Aviv (IL)

(21) Appl. No.: 17/008,555

(22) Filed: Aug. 31, 2020

Related U.S. Application Data
(60) Provisional application No. 62/894,707, filed on Aug. 31, 2019.

(51) Int. Cl. H04N 21/8543; H04N 21/2343

(52) U.S. Cl. CPC H04N 21/8543; H04N 21/23439

(57) ABSTRACT

Systems and methods for providing real time dynamic modification of content in a video receive a markup defining a placement of at least one element in a predefined segment of the video and at least one range regarding the placement; stream the video over a streaming platform to at least a first viewer; initiate a creative request at a predetermined proximity to the placement; receive, based on the creative request, one or more creatives to be rendered as an element within the video based at least on the defined placement and the at least one range; render the creative into the segment; and stream the segment with the rendering to the first viewer in accord with the video.

### CROSS-REFERENCE TO RELATED APPLICATION

This application claims priority to U.S. Provisional Application No. 62/894,707, filed Aug. 31, 2019.

### FIELD OF INVENTION

Generally, the present invention relates to the field for dynamic, real-time, object placement in video content. Specifically, the invention relates to Real-time or next to real-time product placement and other creatives in movies, tv shows, and other videos when streamed digitally.

### BACKGROUND

The World Wide Web was conceived to address a growing need for information sharing between universities around the world. The solution was straightforward: digitized documents, viewable through a browser, linked to one another, in a massive web of information. The World Wide Web model execution utilizes a markup language for text—HTML (Hypertext Markup Language), and a renderer (e.g., a browser), to deliver human legible documents to end users.

The World Wide Web is the execution of Tim Berners-Lee's vision of a “Global Hyperlinked Information System.” Within such a system, linkage is not an optional feature; rather, it is the building blocks that construct the massive web of information—any content incapable of hyperlinkage is therefore, implicitly, not regarded as information.

However, the web's markup language was designed only for text. Only in its fifth iteration, in 2014, was the markup (HTML) introduced a video and audio tag. Prior to HTML5, all non-textual resources were left to their own devices. In order to display a video, publishers had to include non-standard plug-ins, like Silverlight or Flash. HTML5 by no means fixed the disparity. It acknowledged the necessity of providing non-textual resources with a standardized or universal display solution, but it treats those resources as dependents or attachments of textual documents. Similar to decorative items, they are permitted a shelf to stand on, but they are a black box.

For example, product placement is permissible in visual content, it already resides within video content. Sadly, it also “litters” the content as it is currently “hard coded” into it. Currently, there is no way to dynamically remove “temporary” ingredients such as product placements, for long shelf life products such as movies and tv shows.

Real-time dynamic product placement in video does not currently exist on the market. However, companies are attempting to offer what they refer to as “dynamic product placements”. Dynamic product placement is the ability to show a predetermined or prerendered set of products within the same content, and stream different versions to users based on user data, such as region, device and so forth.

Real-time product placement has similar characteristics to standard digital advertising. The brand is determined in real-time, while the user is already streaming, using precise targeting and real-time bidding and rendering.

Mirriad™ uses AI to determine new product placement opportunities. The solution offered is a service helping content owners obtain deals with brands, and then embedding the product into the content prior to airing. While this is dynamic, it not done in real time.

Ryff™ uses placeholders to replace placement images. The placeholders and targeted audience segments can be updated continuously. However, they do not offer real-time bidding and the content is pre-rendered—there is no real-time rendering, individual targeting or mid-stream alterations to content. Furthermore, Ryff only deals with static images—not animation, video, or audio.

SundaySky™ provides vendors with the option to automatically generate dynamic animation for customers. SundaySky does render in real time, with 3 seconds to first frame, however it deals only with animation—not footage, and like the others, once the video starts streaming it has a set course.

Currently available systems and methods in existence have a pre-determined course for the video once it starts streaming. Thus, what is needed are techniques, methods, apparatuses, devices, and/or systems that overcome these disadvantages.

### SUMMARY OF EMBODIMENTS OF THE INVENTION

Embodiments of the invention include systems and methods for providing real time dynamic modification of content in a video. Embodiments of the invention receive at a computer a markup defining a placement of at least one element in a predefined segment of the video and at least one range regarding the placement; stream by the computer the video over a streaming platform to at least a first viewer; initiate by the computer a creative request at a predetermined proximity to the placement; receive, based on the creative request, one or more creatives to be rendered as an element within the video based at least on the defined placement and the at least one range; render the creative into the segment; and stream the segment with the rendering to the first viewer in accord with the video.

In some embodiments, the markup further includes a data model comprising manipulation instructions for a set of one or more frames in a duration of the placement. In some embodiments, the creative request is sent to a set of one or more creative providers; wherein the creative request comprises a bid request and wherein each of the one or more creative providers provides a bid along with the creative to be rendered.

Some embodiments further include validating by the computer the at least one creative; in which validating the at least one creative includes validating that the content to be rendered abides by the at least one range. In some embodiments, the markup is generated in a content editor and is one of uploaded to the server, mounted to the server, and pulled from an external Uniform Resource Locator (URL). In some embodiments, at least a second viewer is streamed a same segment with a different rendering from that streamed to the first viewer. In some embodiments, during a second impression, the first viewer is streamed a same segment with a different rendering from that streamed during a first impression. Some embodiments further include receiving at least one restriction associated with the range.

In accordance with further embodiments of the invention, systems and methods of providing real time dynamic modification of content in a video receive at a computer a markup defining a placement of at least one element in a predefined segment of the video and at least one range regarding the placement; stream by the computer the video over a streaming platform to at least a first viewer; receive, one or more creatives to be rendered as an element within the video based at least on the defined placement and the at least one range; render the creative into the segment; and stream the segment with the rendering to the first viewer in accord with the video.

These and other aspects, features, and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high-level diagram illustrating an example configuration of a system for providing real time dynamic modification of content in a video, according to at least one embodiment of the invention;

FIG. 2 illustrates a typical product placement use case flow example, according to an embodiment of the present invention.

FIG. 3 illustrates components for a system for providing real time dynamic modification of content in a video (also referred to as a Markup-Modify-Render-View Method), according to an embodiment of the present invention.

FIG. 4 is a flow diagram of a method for providing real time dynamic modification of content in a video, according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

Embodiments of the invention enable providing real time dynamic modification of content in a video. Systems and methods described herein allow for full flexibility and are limited only by the level of detail of the markup. Marking up non-textual content allows for any type of real time manipulation to take place. Besides dynamic manipulation of specific segments of the content, hyperlinkage also allows for non-linear and interactive viewing experience to take place, like hyperlinked fiction for visual media.

In some embodiments, the markup, as described in further detail herein, can also be expended to support other forms of content and/or media such as, for example, audio (e.g., music or voice), logical units such as games, virtual reality (VR), augmented reality (AR), and any type of content not yet marked-up by the current web model.

Below is an example of a typical product placement use case according to an embodiment of the invention, which provides Real-Time Bidding (RTB) ad placement, such as placement of a logo or a video commercial into content like such as a movie, television show or a game.

In a non-real-time environment, inserting an ad into content would be a two-step process:

Step 1-Edit: Open the content in an editor (e.g., Avid™ or After Effects™ for video, Unity™ for games, etc.), embed the ad into the content and save it.

Step 2-Render or Compile: render the video or compile the game and send it on its way.

However, RTB caters to masses, the ad to be embedded is often unknown, and the yield must be close to insentience—this is clearly no task for a human. For a machine to be able to embed an ad into content, it needs to “understand” the context—both the content and the ad, need to be machine-legible. An ad delivered via RTB in presently available systems is already machine-legible—its content, duration, size, source and so forth is already known, and any other information needed can easily be added. The content, when served online, has some metadata (e.g., movie title, duration, etc.) but it is widely insufficient.

If a scene within a movie has a television playing in the background, for a machine to embed a video into the television within that scene, not only does it need to know that this is a proper contextual placement, it also must know where the television is positioned within the frame, what size it takes up, whether it is partially obscured by characters or objects in the scene, whether it is rotated in space and so on. Accordingly, in some embodiments of the invention, methods of providing proper contextual placement may be provided, e.g., as follows:

Step 1-Edit: the content author or owner opens the file (e.g., a movie) in an editor like After Effects™. Using an extension embedded into the GUI, for example, the author defines the real estate (the context) of the advertisement.

These editing software platforms provide functionality to translate three-dimensional space into a data structure. Accordingly, in some embodiments, a provided GUI extension enables the author to pin an object (e.g., previously created via the software), thus defining a placement of an element in a predefined segment of the video, and let the editor set ranges and/or restrictions on the placement—like type of ad, ad format (image/video/with/without audio), color pallet and so forth.

In some embodiments, once the content is saved, the extension may extract, e.g., all the relevant data from the software's data model—like position, size, path and effects for each frame in the duration of the placement, etc. In some embodiments, the extension may format the collected data, add its own data on top, such as start/end time of placement, ranges, and ad restrictions, etc., then finally export the markup, e.g., to a text file. Given no visual changes were made to the original content, no rendering is required at this stage.

Similarly, a game developer may open a gaming editor such as Unity™. In some embodiments, an extension may be provided in a similar vein, except data may not be time or frame based. In some embodiments, the developer may set up ad restrictions, e.g., on a textured material and save.

Step 2-Render or Compile: In some embodiments, a video streaming publishing platform may store the markup, e.g., alongside the content—as it does with subtitles.

Step 3-to enable real-time dynamic modification of content, in some embodiments, while the movie or game is streaming and within a predefined proximity of the placement (e.g., close in time, key frame, etc.), in some embodiments, a bid request may be sent out. If an ad comes back and obeys by the placement range and restrictions, the relevant segment may be “pulled”, rendered with the ad (or other creative) based on the markup's instructions, then “put” back into the streamer, as explained in further detail herein.

Embodiments of the invention enable brands to have the ability to target their desired audience and apply accurate measurements. Importantly, the same benefits that extend to content owners apply to brands as well. For example, campaigns have a short life expectancy, their relevance diminished quickly over time. Accordingly, in some embodiments, brands can refresh their ads, fine tune campaigns, and run multiple variations to suit each market, or even each individual, without the requirements of an RTB system and without bid requests. Instead, new creatives can simply be sent to the renderer to be rendered as elements within existing content based on predefined parameters such as placement, range, etc.

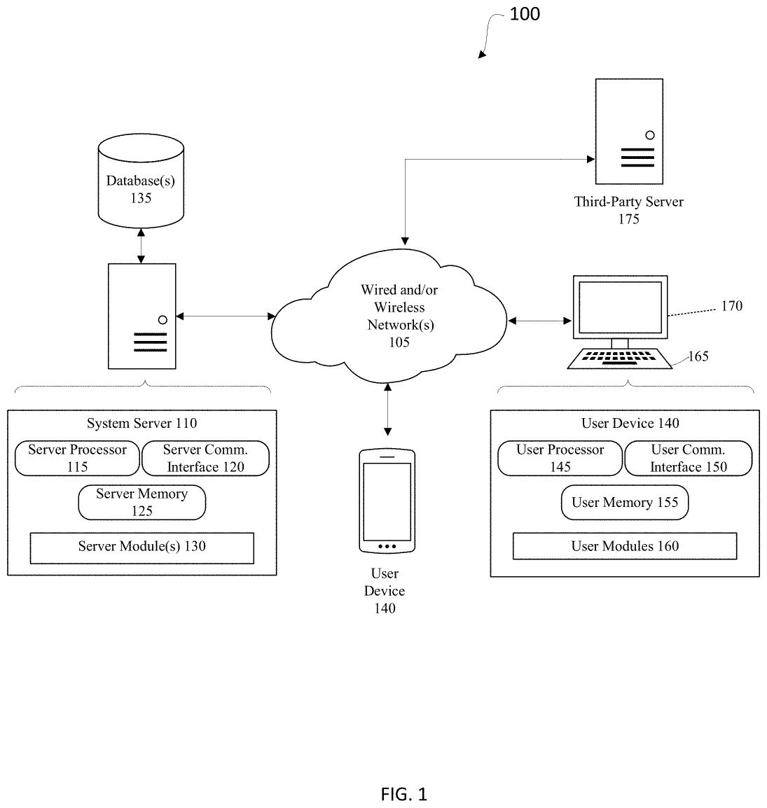

FIG. 1 shows a high-level diagram illustrating an example configuration of a system 100 for providing real time dynamic modification of content in a video, according to at least one embodiment of the invention. System 100 includes network 105, which may include a private operational network, the Internet, one or more telephony networks, one or more network segments including local area networks (LAN) and wide area networks (WAN), one or more wireless networks, or a combination thereof. In some embodiments, system 100 may include a system server 110 constructed in accordance with one or more embodiments of the invention. In some embodiments, system server 110 may be a stand-alone computer system (a computer). In other embodiments, system server 110 may include a decentralized network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, edger servers, mainframes, and other appropriate computers and/or networked or cloud-based computing systems capable of employing the systems and methods described herein.

In some embodiments, system server 110 may include a server processor 115 which is operatively connected to various hardware and software components that serve to enable operation of the system 100. Server processor 115 may serve to execute instructions to perform various operations relating to various functions of embodiments of the invention as described in greater detail herein. Server processor 115 may be one or a number of processors, a central processing unit (CPU), a graphics processing unit (GPU), a multi-processor core, or any other type of processor, depending on the particular implementation.

System server 110 may be configured to communicate via communication interface 120 with various other devices connected to network 105. For example, communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 may be accessible by server processor 115, thereby enabling server processor 115 to receive and execute instructions such a code, stored in the memory and/or storage in the form of one or more software modules 130, each module representing one or more code sets. The software modules 130 may include one or more software programs or applications (collectively referred to as the “server application”) having computer program code or a set of instructions executed partially or entirely in server processor 115 for carrying out operations for aspects of the systems and methods disclosed herein, and may be written in any combination of one or more programming languages. Server processor 115 may be configured to carry out embodiments of the present invention by, for example, executing code or software, and may execute the functionality of the modules as described herein. The one or more software modules 130 may be executed by server processor 115 to facilitate interaction and/or various execute functionalities between and among system server 110 and the various software and hardware components of system 100, such as, for example, server database(s) 135, user device(s) 140, and/or third party system(s) 175 as described herein.

Of course, in some embodiments, server module(s) 130 may include more or less actual modules which may be executed to enable these and other functionalities of the invention. The modules described herein are therefore intended to be representative of the various functionalities of system server 110 in accordance with some embodiments of the invention. It should be noted that in accordance with various embodiments of the invention, server module(s) 130 may be executed entirely on system server 110 as a stand-alone software package, partly on system server 110 and partly on one or more of user device 140 and/or third party system(s) 175, or entirely on user device 140 and/or third party system(s) 175.

Server memory 125 may be, for example, a random access memory (RAM) or any other suitable volatile or non-volatile computer readable storage medium. Server memory 125 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 105. Database 135 may include any of the memory configurations as described herein, and may be in direct or indirect communication with system server 110. In some embodiments, database 135 may store information related to one or more aspects of the invention.

As described herein, among the computing devices on or connected to the network 105 may be one or more user devices 140. User device 140 may be any standard computing device. As understood herein, in accordance with one or more embodiments, a computing device may be a stationary computing device, such as a desktop computer, kiosk and/or other machine, each of which generally has one or more processors, such as user processor 145, configured to execute code to implement a variety of functions, a user communication interface 150, for connecting to the network 105, a computer-readable memory, such as user memory 155, one or more user modules, such as user module 160, one or more input devices, such as input devices 165, and one or more output devices, such as output devices 170. Typical input devices, such as, for example, input devices 165, may include a keyboard, pointing device (e.g., mouse or digitized stylus), a web-camera, and/or a touch-sensitive display, etc. Typical output devices, such as, for example output device 170 may include one or more of a monitor, display, speaker, printer, etc.

In some embodiments, user module 160 may be executed by user processor 145 to provide the various functionalities of user device 140. In particular, in some embodiments, user module 160 may provide a user interface with which a user of user device 140 may interact, to, among other things, communicate with system server 110.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, user device 140 may be a “dummy” terminal, by which processing and computing may be performed on system server 110, and information may then be provided to user device 140 via server communication interface 120 for display and/or basic data manipulation. In some embodiments, modules depicted as existing on and/or executing on one device may additionally or alternatively exist on and/or execute on another device. For example, in some embodiments, one or more modules of server module 130, which is depicted in FIG. 1 as existing and executing on system server 110, may additionally or alternatively exist and/or execute on user device 140 and/or third party server 175. Likewise, in some embodiments, one or more modules of user module 160, which is depicted in FIG. 1 as existing and executing on user device 140, may additionally or alternatively exist and/or execute on system server 110 and/or third party server 175. In some embodiments, third-party server 175 may provide the same or similar structure and/or functionality as system server 110, but may be owned, possessed, and/or operated by a third-party, and/or may provide complementary functionality related to various aspects of the invention.

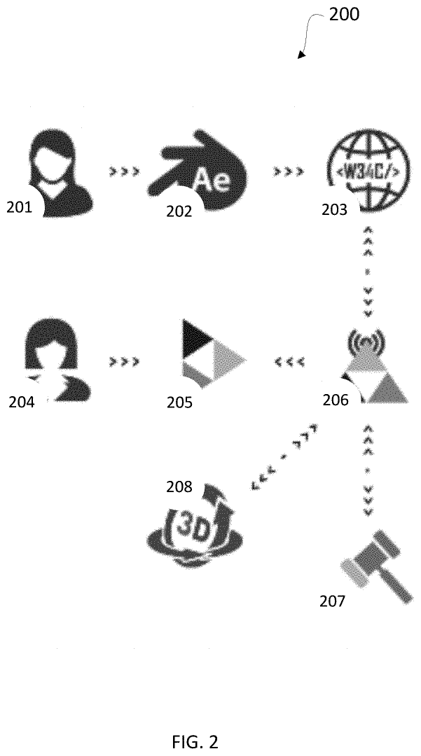

FIG. 2 illustrates a typical product placement use case flow example 200, according to an embodiment of the present invention.

In some embodiments, e.g., during an offline or non-real-time stage, a content owner/creator 201 may open the content in a video editor. Using an extension 202 in the video editor, the content owner/creator 201 may define one or more placements. Once complete, the project may be saved.

As understood herein, an editor or markup generator is a software program, application, extension, or other tool for creating/generating a markup. Just like HTML can be edited with Notepad++ or using a visual editor like Adobe Dreamweaver, a markup needs to be edited with an editor as well. As musicians and video creators are typically not coders, in some embodiments, an extension may be provided by which they may be able to use their existing video/content editors to generate the markup. In some embodiments, creators may create and edit the markup directly as desired. In video, for instance, in some embodiments, an extension/plugin/feature may be added to the software. Adobe After Effects, for example, allows for extensions to be injected into the scope or Blender is an open source program that may be added as a feature or plugin. In some embodiments, the extension/plugin/feature helps the user define dynamic elements and exports the markup, as described herein.

Optionally, in some embodiments, the markup can be written manually without a visual editor. In some embodiments, the markup may be stored on a publicly accessible server with the content.

In some embodiments, saving the project may trigger the markup to be generated and exported. Then, in some embodiments, the content owner/creator 201 by register the markup with the global registry 203. A streamer/streamer proxy 206 (or other computer/server) on a platform licensed to stream the content, may load or otherwise store the new or modified markup alongside the video (e.g., as it does with subtitles). Streamers/Proxy Streamers are not designed to alternate segments or manage modification of the content. Accordingly, in some embodiments, a component within the streamer or outside the streamer in enabled to read the markup and manage the dynamic segments, as described herein.

In some embodiments, the streamer/streamer proxy 206 communicates with various aspects of the system, for example: (A.) A modifier (described herein; in the case of product placement, the streamer may communicate with an RTB platform or bidder). (B.) A renderer (described herein; the streamer/stream proxy may be configured to send the request to a renderer to create a new segment or segments, or an asset that can then be segmented for streaming by the streamer/streamer proxy, and receive a response with the new asset/s location/s). And (C.) The streamer, e.g., the treated segments in the streaming manifest will be symlinked to the newly created segments for the originating viewer, as explained herein).

In some embodiments, the streamer/streamer proxy 206 may (A.) manage the communication; (B.) Convert assets into segments with identical metadata to original segments (so they can be switched in place); (C.) Store segment/s. (D.) Symlink to the new segment for the corresponding user—since all users should use the same streamer manifest. For example, in some embodiments, a streamer/stream proxy may serve an XML or JSON document with a list of segments. The list indicates either an absolute path or relative to where the segment to be streamed is located. Typically, all users will use the same manifest (although this is not be required). However, the users may be served different segment/s. Accordingly, in order to achieve this, in some embodiments, when a segment is fetched from a location specified in the manifest (for instance, http/s://domain.com/segments/100), the streamer/streamer proxy may try to fetch the base URL with, e.g., a query string parameter (e.g., ?param=uid) or a friendly URL (http/s://domain.com/segments/100/uid) where “uid” references a user ID or some unique identifier associated with the view or the viewer. In such embodiments, if the newly constructed URL leads to a new segment, it will stream the new segment; if not, it will stream the default content.

In some embodiments, the renderer (as described herein) may convert assets into segments with identical metadata to original segments (so they can be switched in place) and/or store segment/s.

In some embodiments, during a real-time stage, an end user 204 may view the video on a supported video streaming platform 205 (e.g., PeerTube, Netflix™, etc.). In some embodiments, the video segments may be delivered by the streamer/streamer proxy 206. Based, for example, on timestamp data in the markup, the streamer proxy may initiate a bid request at or within a predefined proximity of future placements, for example, time X, where X>=tmax bid response+tmax validation duration+rendering duration+network.

Of course, the bidder is only applicable when the purpose of dynamically modifying the video is advertising. If the purpose is not advertising, any logical unit can take its place. For example, in some embodiments, a satellite image may be pulled based on the user's geolocation, a time may be pulled based on an IP address, etc.

In some embodiments, the request or requests may be sent to one or more pre-configured bidders 207. In the case of a timely response with content, the streamer/streamer proxy 206 may validate the creatives. If multiple creatives are valid, in some embodiments, the streamer/streamer proxy 206 may promote the highest bid (or some other predefined metric or criteria) to the renderer 208. The creatives are rendered into the corresponding segment or segments and sent back to the streamer/streamer proxy 206, to be streamed into the player of the end user 204.

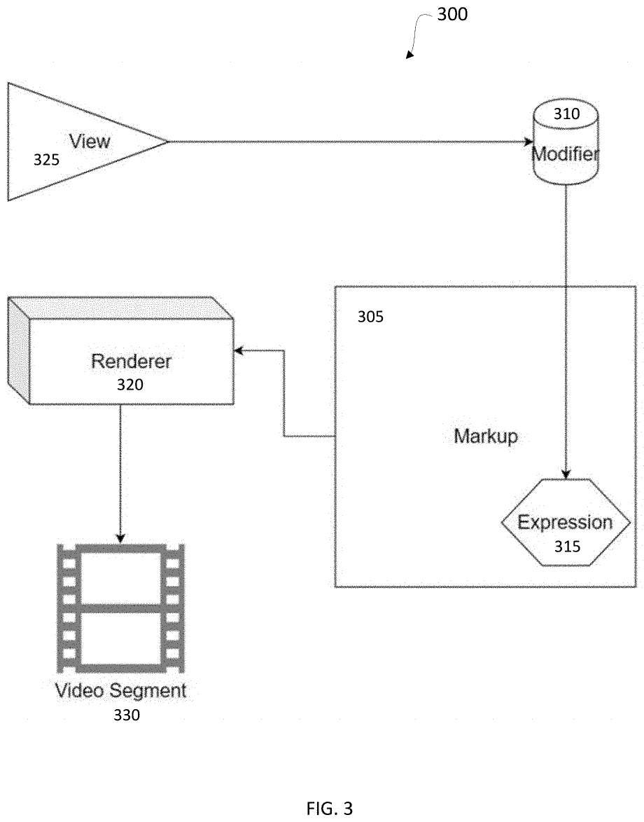

FIG. 3 illustrates components for a system 300 for providing real time dynamic modification of content in a video (also referred to as a Markup-Modify-Render-View Method), according to an embodiment of the present invention. Embodiments of the system may include, for example, a markup 305. A markup, as understood herein, is a file that describes the structure and the content of a video, similar to how HTML describes the structure and content for text. For video, the markup syntax and structure is typically based on modern visual effects (VFX) software, such as Adobe's After effects™ and Blender. As with HTML, hyperlinkage (i.e., the implementation or use of hyperlinks) is one of the core characteristics of the markup. In computing, a hyperlink is a reference to data that the user can follow. A hyperlink points to content or to a specific element within the content. Within the markup not all content is “set in stone”, some of the fields are expressions. The expressions describe parts of the content that are not constants. They allow for variations within a set range of restrictions.

Embodiments of the system may include, for example, a modifier 310. The modifier unit, as understood herein, is the element that generates, in real time (or real time proximity), variables for the expression(s) 315. An expression, as understood herein, refers to a range(s) and/or condition(s)/restriction(s) regarding an element. Since the video is dynamic, some of its objects are not constant and are not represented visually in the video. The markup property for the range of options permitted or the conditions/restrictions to display given elements A, B and/or C, is referred to herein as an expression.

Embodiments of the system may include, for example, a renderer 320. A renderer, as understood herein, is a software component that takes a markup and interpreted it into a displayable form. In some embodiments, the renderer may function similarly to existing video renderers but may use the markup for the rendering instructions. In some embodiments, the renderer may be triggered to work by the streamer/streamer proxy which passes the information/creatives from the modifier In various embodiments this may be based on, for example, a winning bid, user data such as the name of the user, and user ID, location data based on an IP of the user, current time (which may or may not be a simple Coordinated Universal Time (UTC) taken from the computer that is rendering the content or combined with user time-zone information), etc. In some embodiments, the renderer may be configured to store the output, e.g., in cloud storage, mounted to disc, etc., and respond back to the streamer/streamer proxy with the location of the new asset/s. In some embodiments, assets required for the rendering process may optionally be mounted to disc as well.

In some embodiments, the renderer may be configured to interpret the markup and produce video segments. The renderer receives the variable or variables directly or indirectly from the modifier 310, and, using the markup instructions, it renders the variable creative into the “scene” inside the content, producing a video or video segment. In various embodiments, i.e., in a server/client architecture, the rendering may take place on the server side, the client side, a combination of both.

Embodiments of the system may include, for example a view 325. The view contributes to the modifying unit consideration. In some embodiments, the view may be data related to the user, time of day, location, weather, an action that the viewer actively took, etc. In some embodiments, the view, in combination with the markup expression, effects the modifying unit output. In some embodiments, the markup expression and the modifying unit output effect the renderer output.

In some embodiments, the output may be a video segment 330, which is provided to the end user via the streamer/streamer proxy in accord with the video, i.e., at the proper time and/or location such that the segment may be displayed properly to the viewer of the video.

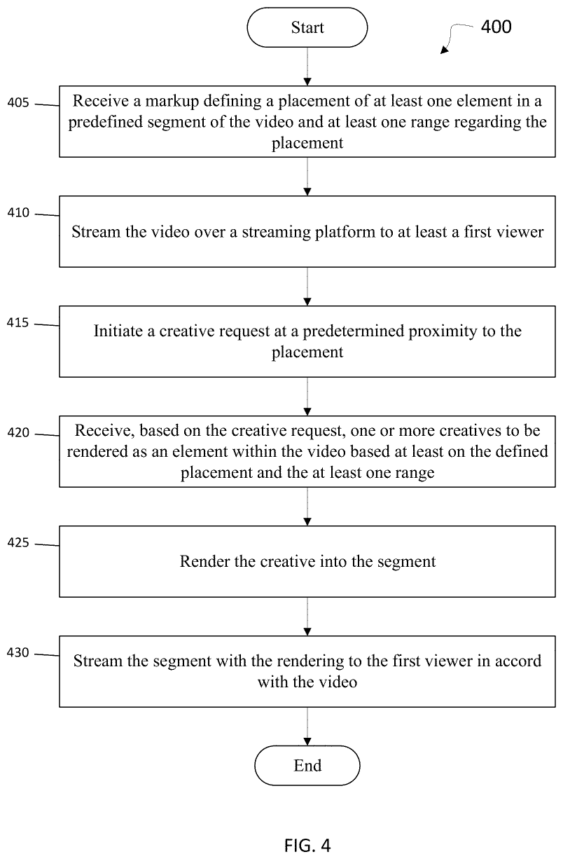

FIG. 4 is a flow diagram of a method 400 for providing real time dynamic modification of content in a video, according to at least one embodiment of the invention. Embodiments of the invention may be performed on a computer having a processor, and memory, and one or more code sets stored in the memory and executing in the processor, as described herein. In some embodiments, the method begins at step 405, when the computer (e.g., a stand-alone computer or server, as described herein) receives a markup defining a placement of at least one element in a predefined segment of the video and at least one range regarding the placement. A segment, as understood herein, may be a set of one or more frames, a partitioned video sequence of consecutive frames according to some predefined criteria, etc. For example, in some embodiments, a streamer may fragment and segment a video in many different ways, independently from what the content owner defined. Additionally, different platforms may segment a video in different ways and even the same streamer may have multiple options for segmentation depending upon the viewer's bandwidth.

In some embodiments, the markup may be generated in a content editor and may be uploaded to the server, mounted to the server, or pulled from an external Uniform Resource Locator (URL). In some embodiments, the markup may be generated outside of a content editor, for instance a code editor or manual editing.

In some embodiments, a defined placement may be based on time, e.g., at a specific timestamp, between two timestamps, a specific length of time after the video has begun streaming, etc. In some embodiments, the placement may me based on keyframe data. In some embodiments, the markup may include, among other things, a data model comprising manipulation instructions for a set of one or more frames in a duration of the placement.

In some embodiments, a range defines what can be accepted as an element. For example, a range may define that the markup can take in any image of a flower of type PNG. In some embodiments, the markup may further include at least one restriction which defines the limits of the range. For example, while the image may be a flower, a restriction may be that the flower cannot be blue nor a rose.

At step 410, the video may be streamed over a streaming platform to at least one or more viewers, e.g., simultaneously, concurrently, etc.

At step 415, the computer may be configured to initiate a creative request at a predetermined proximity to the placement. As noted herein, a creative request is sent when an external RTB system is used, e.g., for the purpose of a product placement. Accordingly, in some embodiments, no creative request is sent. Rather, in some embodiments, the computer may receive one or more creatives to be rendered as an element within the video based, for example, on the viewer's data (e.g., name, location, time zone, etc.), and/or based on the defined placement and range. In some embodiments, the creative request may be sent to a set of one or more creative providers. In some embodiments, the creative request may include, for example, a bid request and each of the one or more creative providers may provide a bid along with the creative to be rendered.

In some embodiments, the predetermined proximity may be a predetermined proximity of time to the placement, which, in some embodiments may be equal to or greater than at least a combination of a maximum bid response, a maximum validation duration, a rendering duration, and a network round trip.

At step 420, e.g., in embodiments in which a creative request has been initiated, the computer may be configured to receive, e.g., based on the creative request, one or more creatives to be rendered as an element within the video based at least on the defined placement and the at least one range. In some embodiments, the computer may be configured to validate the received creatives, e.g., and ensure that at least one creative has content to be rendered that abides by, comports with, or otherwise complies with, e.g., the at least one range and/or the restriction(s), and/or any other defined criteria.

At step 425, in some embodiments, the computer may render the creative into the segment (e.g., via the renderer, as described herein). In some embodiments, e.g., in a server/client architecture, rendering may be performed on the client side, as it typically performed in gaming. In some embodiments, distributors, for example, may prefer to render on the client side (as it saves them the computation cost), presuming the content owner does not stipulate that the rendering be on the server side. In some embodiments, the rendering may be server-side rendering. For example, a production studio may have a requirement the rendering be performed on the server side and then provided to the client.

Finally, at step 430, in some embodiments, the computer may stream the segment with the rendering to the first viewer in accord with the video. For example, in some embodiments, the output may be a video segment, which is provided to the end user via the streamer/streamer proxy in accord with the video, i.e., at the proper time and/or location such that the segment may be displayed properly to the viewer of the video. In some embodiments, different viewers may be streamed the same segments with different renderings from that streamed to other viewers, e.g., based on a user identification or other criteria. Furthermore, in some embodiments, during a second impression to the same viewer, that viewer may be streamed the same segment with a different rendering from that streamed during a first impression previously provided to the viewer. For example, the same segment, e.g., “segment 367”, in which, in a first impression (i.e., the first time the user views segment 367) the segment shows a “United Airways” logo as the airline and in the second impression (i.e., the second time the user views segment 367) it shows an “EL AL Airways” logo.

It should be noted that content generally refers to the video or other media, while the dynamic element used to modify the video is referred to as a creative. A creative may be an image, video, audio, text or any data that can be used to render a new segment.

It should be apparent from this description that aspects of the present invention may be embodied, at least in part, in software. The techniques may be carried out in a computer system (e.g., as described with reference to FIG. 1) or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing the invention described herein will be apparent to those skilled in the art. Although the present invention has been described with reference to specific exemplary embodiments, it will be evident that various modifications and changes may be made to these embodiments without departing from the broader spirit and scope of the invention as set forth herein.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method for providing real time dynamic modification of content in a video, comprising:
receiving at a computer a markup defining a placement of at least one element in a predefined segment of the video and at least one range regarding the placement;
streaming by the computer the video over a streaming platform to at least a first viewer;
initiating by the computer a creative request at a predetermined proximity to the placement;
receiving, based on the creative request, one or more creatives to be rendered as an element within the video based at least on the defined placement and the at least one range;
rendering the creative into the segment; and
streaming the segment with the rendering to the first viewer in accord with the video.

2. The method as in claim 1, wherein the markup further comprises a data model comprising manipulation instructions for a set of one or more frames in a duration of the placement.

3. The method as in claim 1, wherein the creative request is sent to a set of one or more creative providers; wherein the creative request comprises a bid request and wherein each of the one or more creative providers provides a bid along with the creative to be rendered.

4. The method as in claim 1, further comprising validating by the computer the at least one creative; wherein validating the at least one creative comprises validating that the content to be rendered abides by the at least one range.

5. The method as in claim 1, wherein the markup is generated in a content editor and is one of uploaded to the server, mounted to the server, and pulled from an external Uniform Resource Locator (URL).

6. The method as in claim 1, wherein at least a second viewer is streamed a same segment with a different rendering from that streamed to the first viewer.

7. The method as in claim 1, wherein, during a second impression, the first viewer is streamed a same segment with a different rendering from that streamed during a first impression.

8. The method as in claim 1, further comprising receiving at least one restriction associated with the range.

9. A system for providing real time dynamic modification of content in a video comprising:
a computer having a processor, and memory; and
one or more code sets stored in the memory and executing in the processor, which, when executed, configure the processor to:
receive a markup defining a placement of at least one element in a predefined segment of the video and at least one range regarding the placement;
stream the video over a streaming platform to at least a first viewer;
initiate a creative request at a predetermined proximity to the placement;
receive, based on the creative request, one or more creatives to be rendered as an element within the video based at least on the defined placement and the at least one range;
render the creative into the segment; and
stream the segment with the rendering to the first viewer in accord with the video.

10. The system as in claim 9, wherein the markup further comprises a data model comprising manipulation instructions for a set of one or more frames in a duration of the placement.

11. The system as in claim 9, wherein the creative request is sent to a set of one or more creative providers; wherein the creative request comprises a bid request and wherein each of the one or more creative providers provides a bid along with the creative to be rendered.

12. The system as in claim 9, further configured to validate the at least one creative; wherein validating the at least one creative comprises validating that the content to be rendered abides by the at least one range.

13. The system as in claim 9, wherein the markup is generated in a content editor and is one of uploaded to the server, mounted to the server, and pulled from an external Uniform Resource Locator (URL).

14. The system as in claim 9, wherein at least a second viewer is streamed a same segment with a different rendering from that streamed to the first viewer.

15. The system as in claim 9, wherein, during a second impression, the first viewer is streamed a same segment with a different rendering from that streamed during a first impression.

16. The system as in claim 9, further configured to receive at least one restriction associated with the range.

17. A method of providing real time dynamic modification of content in a video, comprising:
receiving at a computer a markup defining a placement of at least one element in a predefined segment of the video and at least one range regarding the placement;
streaming by the computer the video over a streaming platform to at least a first viewer;
receiving, one or more creatives to be rendered as an element within the video based at least on the defined placement and the at least one range;
rendering the creative into the segment; and
streaming the segment with the rendering to the first viewer in accord with the video.

18. The method as in claim 17, wherein the markup is generated in a content editor and is one of uploaded to the server, mounted to the server, and pulled from an external Uniform Resource Locator (URL).

19. The method as in claim 17, wherein at least a second viewer is streamed a same segment with a different rendering from that streamed to the first viewer.

20. The method as in claim 17, wherein, during a second impression, the first viewer is streamed a same segment with a different rendering from that streamed during a first impression.
